(19) United States
(12) Patent Application Publication
(10) Pub. No.: US 2025/0083724 A1
(43) Pub. Date: Mar. 13, 2025

(54) SLIDE-FOLDING HANDCART WITH BACK DOOR

(71) Applicant: Zhejiang Pride Leisure Products Co,. Ltd., Jinhua (CN)

(72) Inventor: Benlong SUN, Jinhua (CN)

(21) Appl. No.: 18/759,791

(22) Filed: Jun. 28, 2024

(30) Foreign Application Priority Data
Jun. 28, 2023 (CN) 202321674227.5

(51) Int. Cl. B62B 3/00; B62B 3/02; B62B 5/06

(52) U.S. Cl. CPC B62B 3/007; B62B 3/025; B62B 5/065; B62B 2205/06

(57) ABSTRACT

A slide-folding handcart with a back door, a frame assembly, wherein the frame assembly has a front bracket, a rear bracket, a chassis and two side brackets; the rear bracket has two rear vertical tubes, two rear fixing bases, a rear horizontal tube, a fence frame and two connecting belts; two ends of the rear horizontal tube are fixed to lower ends of the two rear vertical tubes respectively, two sides of a lower end of the fence frame are riveted to the two ends of the rear horizontal tube respectively, and two sides of an upper end of the fence frame are rotatably connected with upper ends of the rear vertical tubes through the connecting belts respectively.

### BACKGROUND OF THE INVENTION

### 1. Technical Field

The disclosure belongs to the technical field of handcarts, in particular to a slide-folding handcart with a back door.

### 2. Description of Related Art

A handcart is mainly used for manually transporting goods in areas where it is impractical for larger vehicles to access. There are many types of handcarts, such as flatbed handcarts and tipping handcarts, most of which are non-foldable and feature a large size, making it inconvenient for transportation and storage of the handcart itself.

There are also foldable handcarts. For example, the patent with the publication number of “CN218703305U” discloses a novel folding handcart, which comprises a big underframe, a small underframe, a wheel frame, wheels, a pull rod fixing piece, a lower extension rod, a pull rod clamping piece, an extension rod protective sleeve, an upper extension rod, a handle, a small top frame, a big top frame, a support connecting rod, a multi-bend connecting rod, a track pull piece and a cloth basket; a handcart frame body is composed of the big underframe, the small underframe, the small top frame, the big top frame, the plurality of support connecting rods, the multi-bend connecting rod and the track pull piece; a quick-release wheel set composed of the wheel frame and the wheels is arranged on a bottom surface of the handcart frame body; a telescopic pull rod composed of the lower extension rod, the pull rod clamping piece, the extension rod protective sleeve, the upper extension rod and the handle is connected with the handcart frame body; and the cloth basket is arranged in the handcart frame body. Although the handcart in this patent can be folded to be stored during transportation to reduce the volume of the handcart, a side surface of the handcart frame body cannot be disassembled and opened. Therefore, when an item longer than the total length of the handcart is placed in the handcart, one end of the item placed on an upper side of the small top frame opposite to the handle will rise high and roll back and forth at an upper end of the small top frame, which poses a safety hazard during the pushing process of the handcart.

### BRIEF SUMMARY OF THE INVENTION

In view of the defects of the prior art, the disclosure aims to provide a slide-folding handcart with a back door.

In order to achieve the above purpose, the disclosure adopts the following technical scheme: a slide-folding handcart with a back door comprises a frame assembly, and the frame assembly comprises a front bracket, a rear bracket, a chassis and two side brackets; the rear bracket comprises two rear vertical tubes, two rear fixing bases, a rear horizontal tube, a fence frame and two connecting belts; two ends of the rear horizontal tube are fixed to lower ends of the two rear vertical tubes respectively, two sides of a lower end of the fence frame are riveted to the two ends of the rear horizontal tube respectively, and two sides of an upper end of the fence frame are rotatably connected with upper ends of the rear vertical tubes through the connecting belts respectively; a wheel is arranged at the bottom of each rear vertical tube;
the front bracket comprises a rectangular frame consisting of two front vertical tubes, an upper horizontal tube and a lower horizontal tube, and two front fixing bases, each front fixing base is mounted at the top of the corresponding front vertical tube, and wheels are arranged on two sides of the rectangular frame;
each side bracket comprises at least one X-shaped cross tube and two sliders, and the two sliders are respectively disposed around the corresponding front vertical tube and the corresponding rear vertical tube; upper and lower sides of a front end of each side bracket are riveted to the corresponding front fixing base and the slider disposed around the corresponding front vertical tube respectively, and upper and lower sides of a rear end of each side bracket are riveted to the corresponding rear fixing base and the slider disposed around the corresponding rear vertical tube respectively; and the chassis comprises two symmetrically hinged underframes, and front and rear sides of the chassis are riveted to the lower horizontal tube and the rear horizontal tube respectively.

Further, there are two or more X-shaped cross tubes, and upper and lower ends of two adjacent X-shaped cross tubes are hinged together.

Further, the upper and lower ends of the two adjacent X-shaped cross tubes are hinged together by hinges, each of the hinges comprises a left connector and a right connector with symmetrical structures, the left connector or the right connector comprises a riveting part and an inserting part, the two riveting parts of the left connector and the right connector are riveted together, and the inserting parts are inserted into any one of the X-shaped cross tubes and fixed.

Further, the underframe comprises two chassis side tubes, two chassis horizontal tubes and two chassis longitudinal tubes; the two chassis side tubes are parallel to the two chassis longitudinal tubes, and the two chassis side tubes and the two chassis longitudinal tubes are arranged in a bilateral symmetry manner; two ends of each of the two chassis horizontal tubes which are arranged in parallel are respectively fixed to the two chassis side tubes, and two ends of the chassis longitudinal tube are respectively fixed to the two chassis horizontal tubes; and one ends of the chassis side tubes on the same side of the two underframes are riveted together, and the other ends are riveted to the lower horizontal tube or the rear horizontal tube.

Further, in the underframes, the chassis side tubes are each provided with a longitudinal tube groove-shaped component with a downward-facing opening near the center of the handcart, the longitudinal tube groove-shaped component is provided with a downward extending connecting part towards the center of the handcart, and the two underframes are riveted together corresponding to the two connecting parts on the left or right side.

Further, upper limit protrusions and lower limit protrusions are disposed on the front vertical tubes and the rear vertical tubes respectively.

Further, the frame assembly also comprises a handle assembly, the handle assembly comprises a handle, an extension rod and a pull rod connector which are sequentially arranged from top to bottom, and the pull rod connector is rotatably connected with the lower horizontal tube of the front bracket, and is able to rotate toward or away from the front bracket.

Further, the handle assembly also comprises a U-shaped piece fixed on a front side of a middle part of the lower horizontal tube, and the pull rod connector is embedded in the U-shaped piece for riveted connection.

Further, in the front bracket, the two wheels are respectively mounted at bottom parts of two front vertical tubes, or the two wheels are mounted on left and right sides of the lower horizontal tube.

Further, the slide-folding handcart with a back door also comprises a cloth bag placed in the frame assembly, wherein a rear side of the cloth bag is foldable, and an upper edge of the rear side is detachably connected with the fence frame.

Further, each connecting belt is provided with an adjustable buckle.

By adopting the technical scheme of the disclosure, the disclosure has the beneficial effects: the foldable design of the fence frame of the rear bracket reduces the inclination angle of items, exceeding the length of the handcart, placed in the handcart, and increases the supporting area for the items, so compared with conventional handcarts, the probability of items rolling over during transportation is significantly decreased; moreover, the entire handcart can be folded for easy storage, occupying less space when not in use and facilitating portability.

### BRIEF DESCRIPTION OF THE SEVERAL VIEWS OF THE DRAWINGS

FIG. 1 is a perspective view of a back side of a first slide-folding handcart with a back door;

FIG. 2 is a perspective view of a front side of a first slide-folding handcart with a back door;

FIG. 3 is a side view of a first slide-folding handcart with a back door;

FIG. 4 is a perspective view of a first slide-folding handcart with a back door on which a cloth bag is mounted;

FIG. 5 is an exploded view of a first slide-folding handcart with a back door on which a cloth bag is mounted;

FIG. 6 is a perspective view of a back side of a second slide-folding handcart with a back door;

FIG. 7 is a perspective view of a front side of a second slide-folding handcart with a back door;

FIG. 8 is a perspective view of a second slide-folding handcart with a back door on which a cloth bag is mounted; and

FIG. 9 is an exploded view of a second slide-folding handcart with a back door on which a cloth bag is mounted.

In the figures: 1 front bracket, 11 front vertical tube, 12 upper horizontal tube, 13 lower horizontal tube, 14 front fixing base, 2 rear bracket, 21 rear vertical tube, 22 rear fixing base, 23 rear horizontal tube, 24 fence frame, 25 connecting belt, 26 adjustable buckle, 3 side bracket, 31 X-shaped cross tube, 32 hinge, 33 slider, 4 chassis, 41 underframe, 41a chassis side tube, 41b chassis horizontal tube, 41c chassis longitudinal tube, 42 longitudinal tube groove-shaped component, 42a connecting part, 43 chassis fixing piece, 5 wheel, 51 wheel frame, 6 handle assembly, 61 handle, 62 extension rod, 63 pull rod connector, 64 U-shaped piece, 7 cloth bag, 71 rear side, 72 mounting part, 8 upper limit protrusion, 9 lower limit protrusion.

### DETAILED DESCRIPTION OF THE INVENTION

The specific embodiments of the disclosure will be further elaborated with the attached drawings to make the technical scheme clearer.

### Embodiment 1

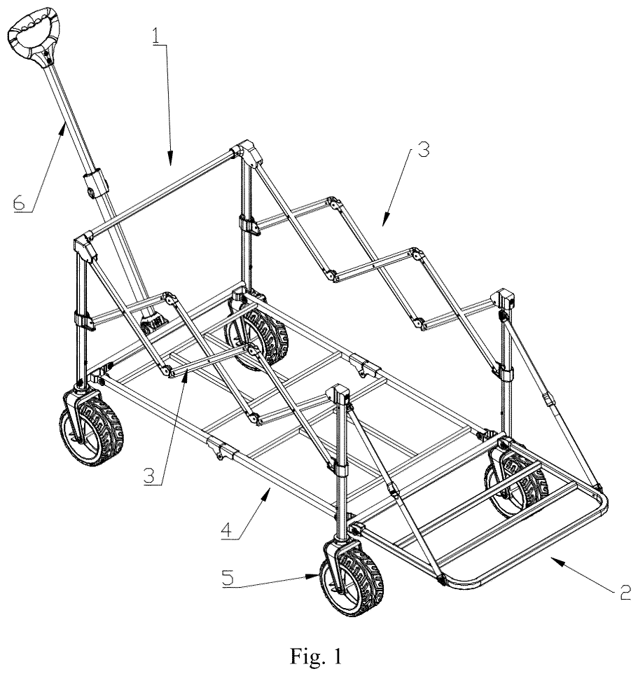

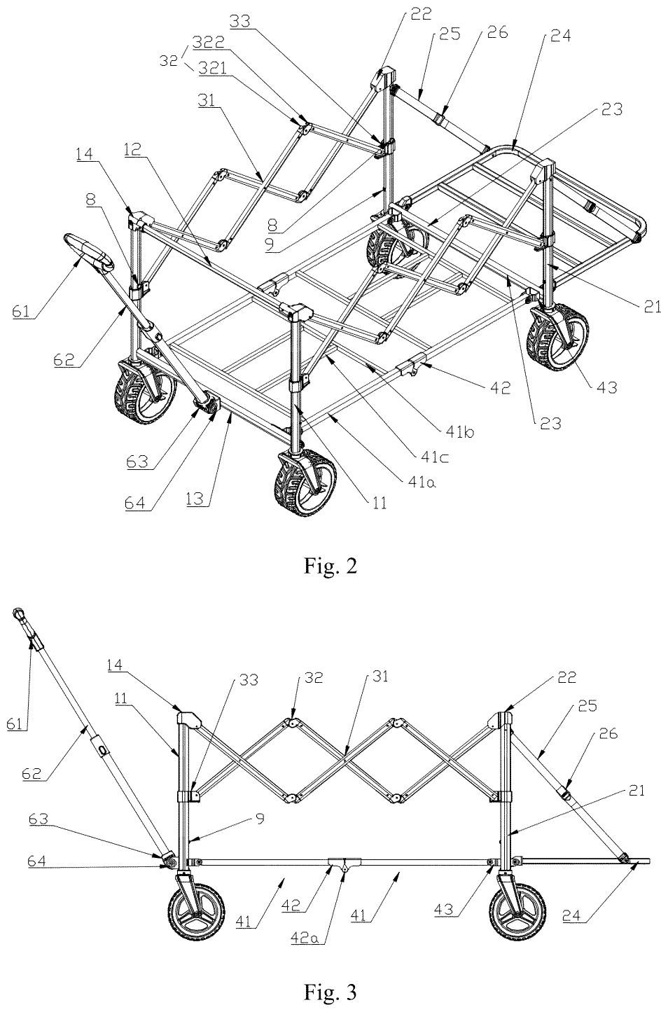

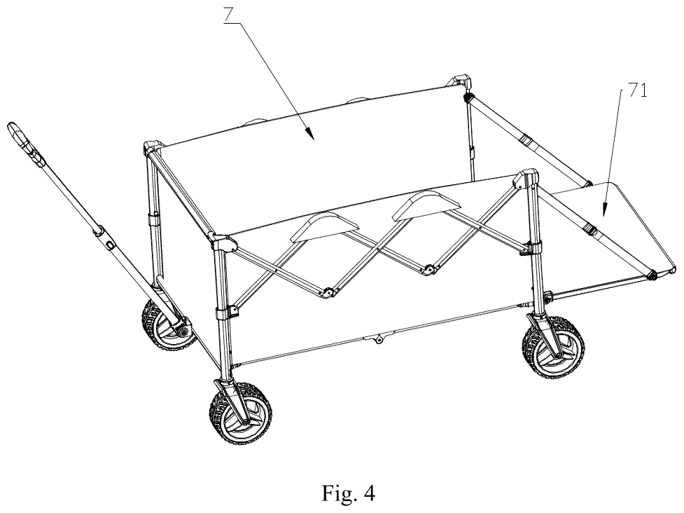

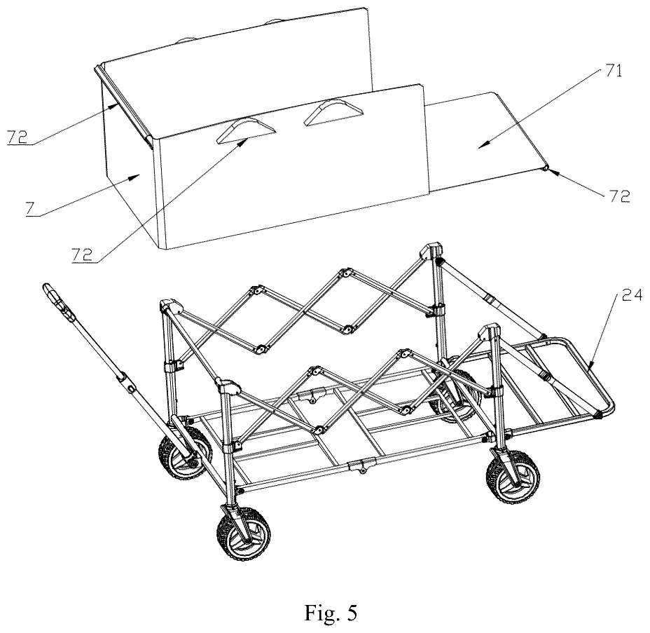

As shown in FIGS. 1-5, this embodiment discloses a slide-folding handcart with a back door, which comprises a frame assembly, and the frame assembly comprises a front bracket 1, a rear bracket 2, two side brackets 3 and a chassis 4.

The rear bracket 2 comprises two rear vertical tubes 21, two rear fixing bases 22, a rear horizontal tube 23, a fence frame 24 and two connecting belts 25; two ends of the rear horizontal tube 23 are fixed to lower ends of the two rear vertical tubes 21 respectively, two sides of a lower end of the fence frame 24 are riveted to the two ends of the rear horizontal tube 23 respectively, and two sides of an upper end of the fence frame 24 are rotatably connected with upper ends of the rear vertical tubes 21 through the connecting belts 25 respectively; and a wheel 5 is arranged at the bottom of each rear vertical tube 21, and the fence frame 24 adopts a structure in which two parallel tubes are arranged in an N-shaped tube.

The front bracket 1 comprises a rectangular frame consisting of two front vertical tubes 11, an upper horizontal tube 12 and a lower horizontal tube 13, and two front fixing bases 14, each front fixing base 14 is mounted at the top of the corresponding front vertical tube 11, and wheels 5 are arranged on two sides of the rectangular frame.

Each side bracket 3 comprises at least one X-shaped cross tube 31 and two sliders 33, and the two sliders are respectively disposed around the corresponding front vertical tube 11 and the corresponding rear vertical tube 21; upper and lower sides of a front end of each side bracket 3 are riveted to the corresponding front fixing base 14 and the slider disposed around the corresponding front vertical tube 11 respectively, and upper and lower sides of a rear end of each side bracket 3 are riveted to the corresponding rear fixing base 22 and the slider disposed around the corresponding rear vertical tube 21 respectively; and the chassis 4 comprises two symmetrically hinged underframes 41, and front and rear sides of the chassis 4 are riveted to the lower horizontal tube 13 and the rear horizontal tube 23 respectively.

In the side bracket 3 of this embodiment, there are three X-shaped cross tubes 31, and upper and lower ends of two adjacent X-shaped cross tubes 31 are connected by hinges 32; the each of the hinges 32 comprises a left connector 321 and a right connector 322 with symmetrical structures, the left connector 321 or the right connector 322 comprises a circular riveting part and a square inserting part, the two riveting parts of the left connector 321 and the right connector 322 are riveted together, and the inserting parts are inserted into any one of the X-shaped cross tubes and fixed by fasteners such as screws; and because the two riveting parts of each hinge 32 are riveted together, relative rotate on is made possible, thereby enabling rotation between the corresponding two tubes.

In order to control the longitudinal moving distance of the sliders 33, each of the front vertical tubes 11 is provided with an upper limit protrusion 8 and a lower limit protrusion 9, each of the rear vertical tubes 21 is provided with upper limit protrusion 8 and a lower limit protrusion 9.

The underframe 41 of this embodiment comprises two chassis side tubes 41a, two chassis horizontal tubes 42b and two chassis longitudinal tubes 41c; the two chassis side tubes 41a are parallel to the two chassis longitudinal tubes 41c, and the two chassis side tubes 41a and the two chassis longitudinal tubes 41c are arranged in a bilateral symmetry manner; two ends of each of the two chassis horizontal tubes 42b which are arranged in parallel are respectively fixed to the two chassis side tubes 41a, and two ends of the chassis longitudinal tube 41c are respectively fixed to the two chassis horizontal tubes 42b; one ends of the chassis side tubes 41a on the same side of the two underframes are riveted together, and the other ends are riveted to the lower horizontal tube 13 or the rear horizontal tube 23; and the tubes of the underframe 41 are securely joined together, forming a cohesive unit.

In order to realize the hinging of the two underframes 41, the two chassis side tubes are each provided with a longitudinal tube groove-shaped component 42 with a downward-facing opening near the center of the handcart, the longitudinal tube groove-shaped component 42 is provided with a downward extending connecting part 42a towards the center of the handcart, and the two underframes are riveted together corresponding to the two connecting parts 42a on the left or right side; and when folding, the two short horizontal tubes 41c in the middle are pulled up, and the joint of the two underframes, that is, the riveting part of the two longitudinal tube groove-shaped components 42, arches upward, allowing the two underframes to gradually come together.

The chassis 4 also comprises four U-shaped chassis fixing pieces 43, through which the chassis is connected with the front bracket 1 and the rear bracket 2, two of the chassis fixing pieces 43 are respectively fixed to inner sides of two ends of the lower horizontal tube 13 of the front bracket 1 or the rear horizontal tube 23 of the rear bracket 2 facing the center of the handcart, and the other end of the chassis side tube 41a is embedded in a U-shaped opening of the chassis fixing piece 43 to realize riveted connection.

By pulling up the two chassis horizontal tube 41b near the longitudinal tube groove-shaped components 42, a narrowing side of the underframe 41 rotates upwards, and then lower surfaces of the two underframes 41 gradually come close together, completing the folding of the chassis 4.

When the whole handcart is folded to be stored, middle parts of the two underframes 41 move up and gather together, and two of the X-shaped cross tubes which are riveted together come close to each other; at the same time, the front bracket 1 and the rear bracket 2 connected with the front and rear ends of the side bracket 3 converge towards the middle, achieving the gradual convergence and folding of the front bracket 1 and the rear bracket 2, and ultimately transforming the entire frame assembly from an expanded usage state into a folded state; in this way, occupied space is reduced, and the batch packaging and transportation of the folding handcart are facilitated.

The front bracket 1 of the frame assembly is also provided with a handle assembly 6, the handle assembly 6 comprises a handle 61, an extension rod 62 and a pull rod connector 63 which are sequentially arranged from top to bottom, and the pull rod connector 63 is rotatably connected with the lower horizontal tube 13 of the front wall 1, and is able to rotate toward or away from the front wall. The handle 61 is made of plastic.

The handle assembly 6 also comprises a U-shaped piece 64 fixed on a front side of a middle part of the lower horizontal tube 13, an opening of the U-shaped piece 64 faces forward, and the pull rod connector 63 is embedded in the U-shaped piece 64 for riveted connection.

In this embodiment, both the chassis fixing piece 43 and the U-shaped piece 64 are made of metal, and the tubes in the chassis 4 are metal square tubes. The tubes in the side wall 3 are metal elliptical tubes. Riveting in this embodiment is movable riveting.

In the front bracket 1, the two wheels 5 are respectively mounted at the bottom parts of two front vertical tubes 11.

In order to fix and adjust the opening angle of the fence frame conveniently, an adjustable buckle 26 is arranged on the connecting belt 25, and the length of the connecting belt 25 is adjusted through the adjustable buckle, so that the fence frame 24 can be opened by different angles relative to the whole frame assembly.

The handcart also comprises a cloth bag 7 placed on the frame assembly, with four side surfaces detachably connected with the front bracket 1, the rear bracket 2 and the two side brackets 3 respectively. A rear side 71 of the cloth bag 7 can be folded, and an upper edge of the rear side 71 is detachably connected with the fence frame 24. The cloth bag 7 has no top surface, and a front side surface is fixed around the upper horizontal tube 12 of the front bracket through a foldable hook and loop fastener. A side surface may not be fixed, or is provided with a fixing part 72 which is fixed to a hinging part in the side bracket 3 through a downward-facing mounting opening. The frame assembly is composed of a plurality of tubular parts, and there are significant gaps between the parts, allowing for the storage of large-sized items. However, it is not suitable for holding small items as they might fall out while the handcart is in motion. Hence, to enable the storage of small items, the removable cloth bag 7 which can be easily detached and cleaned is arranged on the frame assembly.

### Embodiment 2

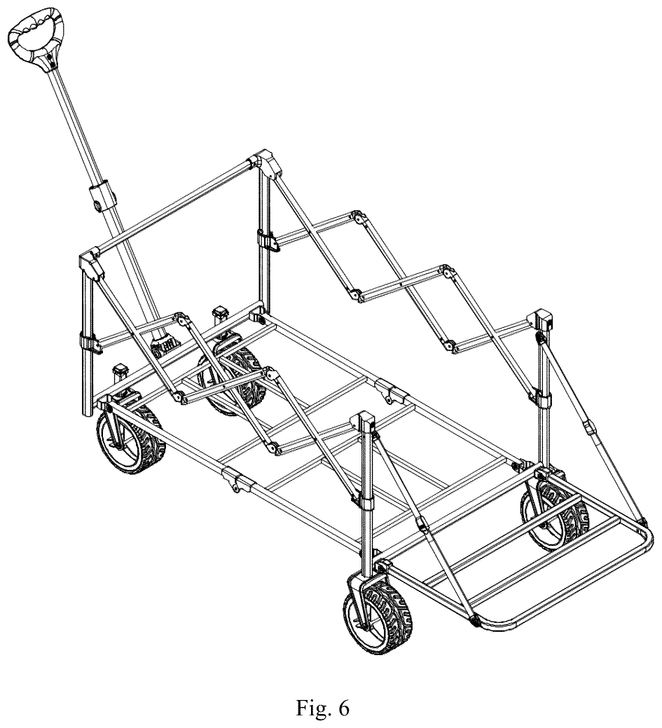

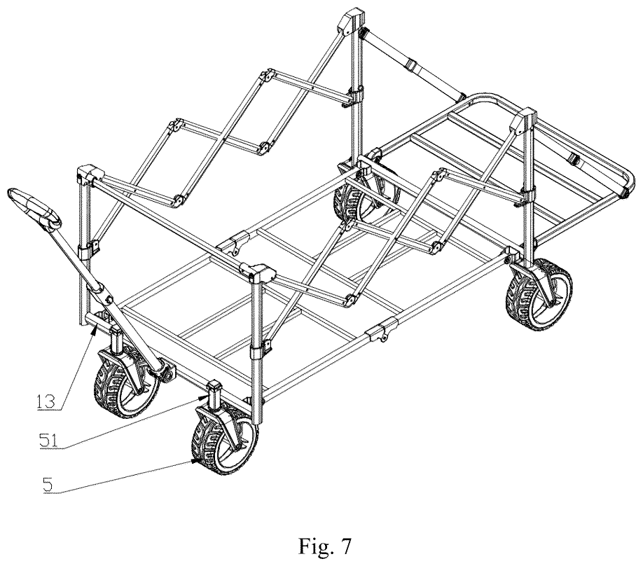

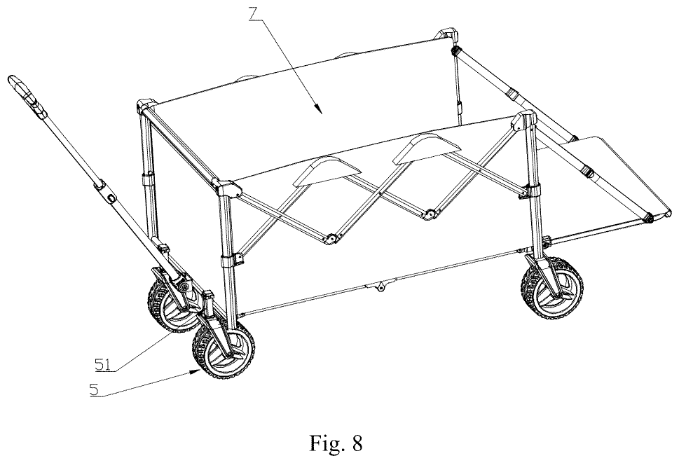

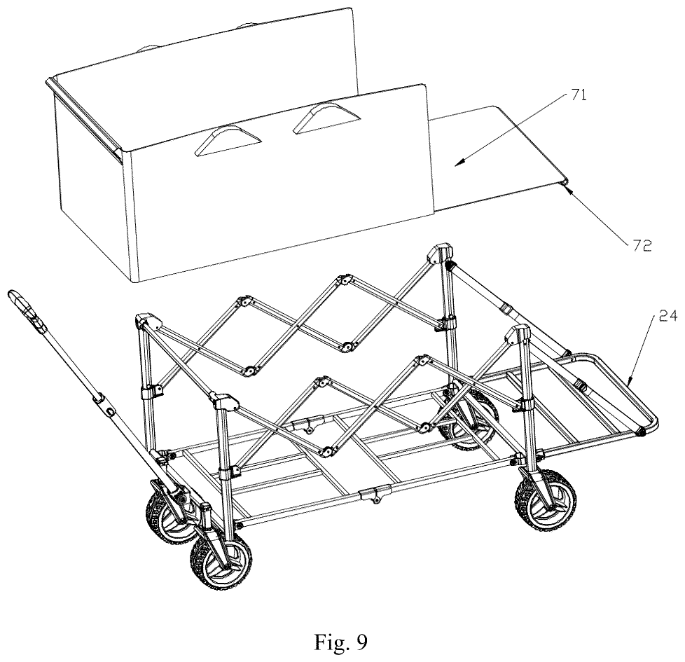

Different from Embodiment 1, as shown in FIGS. 6-9, in a slide-folding handcart with a back door in this embodiment, two wheels 5 on a front bracket 1 are directly welded to left and right sides of a lower horizontal tube 13 through wheel frames 51 at the upper ends of the wheels, and are located in front of the lower horizontal tube 13.

It should be noted that the above embodiments are only preferred ones of the disclosure and technical principles applied thereto. Those skilled in the art will understand that the disclosure is not limited to the specific embodiments described here, and those skilled in the art can make various obvious changes, readjustments and substitutions without departing from the protection scope of the disclosure. Therefore, although the disclosure has been described in detail through the above embodiments, the disclosure is not limited to the above embodiments, but can also include more equivalent embodiments without departing from the concept of the disclosure, and the scope of the disclosure is determined by the scope of the appended claims.

What is claimed is:

1. A slide-folding handcart with a back door, comprising:
a frame assembly, wherein the frame assembly comprises a front bracket, a rear bracket, a chassis and two side brackets;
the rear bracket comprises two rear vertical tubes, two rear fixing bases, a rear horizontal tube, a fence frame and two connecting belts;
wherein two ends of the rear horizontal tube are fixed to lower ends of the two rear vertical tubes respectively, two sides of a lower end of the fence frame are riveted to the two ends of the rear horizontal tube respectively, and two sides of an upper end of the fence frame are rotatably connected with upper ends of the rear vertical tubes through the connecting belts respectively;
wherein a wheel is arranged at a bottom of each said rear vertical tube;
wherein the front bracket comprises a rectangular frame consisting of two front vertical tubes, an upper horizontal tube and a lower horizontal tube, and two front fixing bases, each said front fixing base is mounted at a top of the corresponding front vertical tube, and wheels are arranged on two sides of the rectangular frame;
wherein each said side bracket comprises at least one X-shaped cross tube and two sliders, and the two sliders are respectively disposed around the corresponding front vertical tube and the corresponding rear vertical tube;
wherein upper and lower sides of a front end of each said side bracket are riveted to the corresponding front fixing base and the slider disposed around the corresponding front vertical tube respectively, and upper and lower sides of a rear end of each said side bracket are riveted to the corresponding rear fixing base and the slider disposed around the corresponding rear vertical tube respectively; and
wherein the chassis comprises two symmetrically hinged underframes, and front and rear sides of the chassis are riveted to the lower horizontal tube and the rear horizontal tube respectively.

2. The slide-folding handcart with a back door according to claim 1, wherein there are two or more X-shaped cross tubes, and upper and lower ends of the two adjacent X-shaped cross tubes are hinged together.

3. The slide-folding handcart with a back door according to claim 2, wherein the upper and lower ends of the two adjacent X-shaped cross tubes are hinged together by hinges, each of hinges comprises a left connector and a right connector with symmetrical structures, the left connector or the right connector comprises a riveting part and an inserting part, the two riveting parts of the left connector and the right connector are riveted together, and the inserting parts are inserted into any one of the X-shaped cross tubes and fixed.

4. The slide-folding handcart with a back door according to claim 1, wherein upper limit protrusions and lower limit protrusions are disposed on the front vertical tubes and the rear vertical tubes respectively.

5. The slide-folding handcart with a back door according to claim 1, wherein the underframe comprises two chassis side tubes, two chassis horizontal tubes and two chassis longitudinal tubes; the two chassis side tubes are parallel to the two chassis longitudinal tubes, and the two chassis side tubes and the two chassis longitudinal tubes are arranged in a bilateral symmetry manner; two ends of each of the two chassis horizontal tubes which are arranged in parallel are respectively fixed to the two chassis side tubes, and two ends of the chassis longitudinal tube are respectively fixed to the two chassis horizontal tubes; and one ends of the chassis side tubes on the same side of the two underframes are riveted together, and the other ends are riveted to the lower horizontal tube or the rear horizontal tube.

6. The slide-folding handcart with a back door according to claim 5, wherein in the underframes, the chassis side tubes are each provided with a longitudinal tube groove-shaped component with a downward-facing opening near a center of the handcart, the longitudinal tube groove-shaped component is provided with a downward extending connecting part towards the center of the handcart, and the two underframes are riveted together corresponding to the two connecting parts on the left or right side.

7. The slide-folding handcart with a back door according to claim 1, wherein the frame assembly also comprises a handle assembly, the handle assembly comprises a handle, an extension rod and a pull rod connector which are sequentially arranged from top to bottom, and the pull rod connector is rotatably connected with the lower horizontal tube of the front bracket, and is able to rotate toward or away from the front bracket.

8. The slide-folding handcart with a back door according to claim 1, wherein the handle assembly also comprises a U-shaped piece fixed on a front side of a middle part of the lower horizontal tube, and the pull rod connector is embedded in the U-shaped piece for riveted connection.

9. The slide-folding handcart with a back door according to claim 1, wherein in the front bracket, the two wheels are respectively mounted at bottom parts of two front vertical tubes, or the two wheels are mounted on left and right sides of the lower horizontal tube.

10. The slide-folding handcart with a back door according to claim 1, further comprising a cloth bag placed in the frame assembly, wherein a rear side of the cloth bag is foldable, and an upper edge of the rear side is detachably connected with the fence frame;
alternatively, each said connecting belt is provided with an adjustable buckle.
